(19) United States
(12) Patent Application Publication
(10) Pub. No.: US 2012/0222993 A1
(43) Pub. Date: Sep. 6, 2012

(54) FLOAT FOR INSPECTING SEWER SYSTEMS

(76) Inventor: Philippe Biesse, Bellegarde (FR)

(21) Appl. No.: 13/376,176

(22) PCT Filed: May 27, 2010
(86) PCT No.: PCT/FR10/00395

§ 371 Date: Feb. 21, 2012

(30) Foreign Application Priority Data
Jun. 3, 2009 (FR) 0902662

(51) Int. Cl. H04N 7/18; E03B 5/06

(52) U.S. Cl. 210/85; 348/81; 348/E07.085

(57) ABSTRACT

The device used for collecting information on the condition of a sewer network.

It includes a set of observation devices mounted on a floating housing (1) introduced in the sewer pipe flow and connected by the rear (8) to a check cable which the operator can unreel from the surface of an upstream manhole, and is completed by display, control and optional recording systems on the surface.

The on-board devices comprise a pan and tilt surface camera housed behind a glass dome (2), a bottom camera (3), distance detectors (6 and 7), a system transmitting wireless signals (5), lights, and batteries (4). The signals run along the inside of the pipe to a receiver located at a manhole and from there are transmitted to the station on the surface.

The components are compact, reliable and preferably derived from mass-produced devices such as video surveillance cameras, computers or video screens.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION BY REFERENCE OF MATERIAL SUBMITTED ON A COMPACT DISC

Not Applicable

### BACKGROUND OF THE INVENTION

1/ Technical Field

This invention refers to a device that helps a sewage network manager collect information about the condition of the network in order to maintain it in good operating condition.

A network needs to be cleaned periodically to get rid of deposits and other obstructing materials and to guarantee optimal flow of the water through its pipes.

The cleaning process needs to be done every 6 month to 12 years with an average periodicity of 3 years depending on the characteristics of the network.

The purpose of network monitoring is to adjust the cleaning frequency and to check the pipes for structural condition or other problems.

2/ Background Art

Traditionally, man holes and pipes of big dimensions are observed directly by visiting them. For smaller pipes, the inspection can be made from the top of a visiting chamber with the help of a wired camera fitted at the lower extremity of a vertical pole put in the chamber down to the pipe inlet, and that can observe the inside of the pipe on a limited length.

This kind of inspection is more or less complete, and more or less difficult to implement whether it is realized directly without preparing the pipe or after draining and cleaning it.

Another usual method is to insert a wired camera mounted on a remote control wheeled cart that moves inside the pipe after the latter has been drained and cleaned.

The drawbacks of these methods are that they involve, depending on the situation:
The presence of a person inside a confined environment with hygiene risk and exposure to dangerous gas like H2S,
The continuous presence of a complete team including someone able to interpret the observation, such a team being generally mobilized during day time when the sewage flow is maximum.
A low ratio of distance of piping observed over time spent and means deployed.
A necessity to cut or limit the water flow in the pipe which then cannot accomplish its primary function during the observation or that has to be by-passed by an alternate system to be installed,
A relatively regular bottom surface of the pipe without big obstacles or differences in level for the cart to be able to progress smoothly,
Expensive equipment that are limited in number and cannot be used in situations where there is a risk of damage or loss.
The opening of many chambers for access, display and ventilation and thus causing odours, safety and circulation problems for the neighbourhood,
Limited distance between visiting chambers to allow observation of the whole piping section.

The following patents are related to the art.

Patent DE 4114601 describes a wheeled inspection unit moved along inside the sewage pipes and connected to a control and evaluation unit at least partially without.

Patent DE 4208863 describes an arrangement which has a transport mechanism with a signal generator and receiver. The signal generator is in the form of a microwave generator which produces synthetic pulses.

Patent EP 1749944 describes an inspection device which has compressed air supply for cleaning of water when positioning the pressure-tight housing at the channel wall. A waterproof camera unit is provided for taking pictures of the channel wall in the housing.

Patent DE29900544 which describes a device that transmits visual information of a sewer pipe to a display unit at the surface. The device consists of a housing in which a camera and lights linked by wire to a display unit at the surface and a nozzle used to push the device inside the pipe.

Patent DE9320538 describes a wheeled housing in which a camera, a location sensor and a storage unit are fitted, used to record visual and location information in a pipe and to deliver them afterwards to a processing and visualization unit at the surface.

Patent DE20 2006 016 642 describes a floating housing on which is fitted a camera and a lighting system and is held on one side by an electrical wire (to transmit signals and to exert a pulling or retaining action) and pulled on the other side by cleaning nozzles normally used for cleaning sewer piping.

### BRIEF SUMMARY OF THE INVENTION

The invention allows remedying these drawbacks while ensuring an easy and economical way of estimating if cleaning is required and where the deposits are located, helping in the performance of the periodical inspection of networks and in the follow up of the evolution of some known disorders or the evolution of the structure after repairing work.

It consists in using a set of observation equipment mounted on a floating housing linked at its rear to a check cable that the operator located at the surface of the upstream visiting chamber can control.

The observation equipment is fed electrically by the inboard direct current battery and emit signals via electromagnetic waves that are relayed by one (or several) antenna along the inside of the pipe up to the antenna of a receiver located in the upstream or alternately in the downstream visiting chamber, and are finally transmitted wireless or by cable up to the observation and recording unit located on the surface.

The selected equipment is lightweight, reliable, and preferably derived from widely commercialized series of equipment in order to be cheap.

### BRIEF DESCRIPTION OF THE DRAWINGS

FIG. 1 represents a transparent perspective view of the float for inspecting sewer systems with main equipment. The configuration and equipment represented are not limited within the framework of the invention, the dimensions and the shapes are simplified for visual clarity.

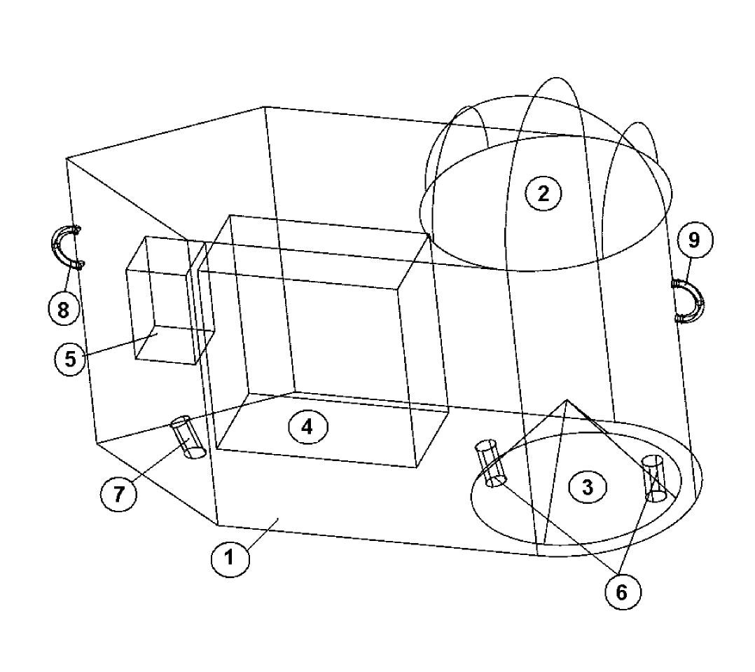

Floating housing (1) and its main equipment, the glass dome housing the surface camera (2), the window at the bottom of the floating housing under the floatation line housing the bottom camera (3), the battery (4), the electronic signal transmitting block (5), the light beam distance detectors (6), another rear distance detector (7), the rear hook (8) for check cable, the front hook (9) for traction cable.

### DETAILED DESCRIPTION OF THE INVENTION

According to a first characteristic, the device includes a floating housing made up of a middle lower compartment which houses the batteries, of a front lower compartment with a camera behind a transparent, water tight and shock resistant port hole located under the waterline and facing down, of a top front water tight transparent glass dome housing a camera, preferably swivelling or pan and tilt type, of a rear compartment containing the electronics for signal transmission and antennas and optional windows with can house distance measurement systems.

The outer surface of the housing guarantees water tight junction to the various windows, and a water tight removable cap closes over the upper middle part so that the different components can be fit or removed. The water tightness will be the best possible to avoid water penetration as welt as gas penetration in order to prevent the effects of oxidation from HS2. This waterproofing can be improved by applying flexible covering on the joints after assembly of the equipment in the housing and by using tropicalized electronics or desiccant bags. The charge of the battery is made without opening the housing via an outside socket.

The shape and volume of the housing and the location of heavy elements under the waterline insures its floatability and pitch, roll and yaw stability in spite of the turbulent water flow in the pipes.

The glass pane of the front lower porthole is in direct contact with the water which facilitates the visualization through the liquid. The upper glass dome is made of anti-shock material and is preferably protected by metal stems. The housing material can be metallic, plastic, glass-fibre reinforced resin or any other adequate material.

The location of the signal transmission components and the material of the housing section around them are chosen and designed not to interfere with the transmission of electromagnetic waves.

According to a second characteristic, the device includes a thin cable that allows the operator to control the progression of the floating housing on the water flow.

The cable is long enough to allow the displacement of the housing over the distance of one or several intervals between visiting chambers, and is thin enough to make up a light, trim bobbin when rolled up. It is composed of braided fibres, or nylon single strand like in a fishing rod, or multi-strands steel cable or other kinds of cable material to be determined in relation to the distance between visiting chambers, the strength required, and the minimizing of the drag in the water flow and of the risks of getting stuck or jammed.

There are advantages in using a light cable that floats on the water surface rather than a cable that drags on the bottom deposits, or a single strand cable that does not absorb water and is easier to drain and clean.

The bobbin can be reeled manually or mechanically like a fishing rod reel.

The lowering of the cable to the bottom of the visiting chamber can be achieved by simply unrolling it down or by having it guided by an extension pole.

The complete bobbin set can take the shape of a telescopic fishing rod, reel and nylon cable. To optimize the observation, the operator will choose the period of day with most favourable water level, speed, stability of flow, and clarity of water in the pipe. These conditions may not be sufficient to insure the forward move of the floating housing in the pipe. It is possible to create this forward movement through traction on another cable placed at the front of the housing. This other cable being previously introduced in the pipe with a floating object tied at its extremity when the water flow was strong enough to draw the set to the next visiting chamber.

It would be possible to motorize the housing like a boat or a remote controlled miniature submarine, however, the cable is a guarantee that one can pull the float back to the visiting chamber when damage or loss of contact of any other system would not.

According to a third characteristic, the device includes a surface camera, preferably of swivelling, pan and tilt type. It can also be without swivelling capability depending on pipe diameter and picture angle of its lens, or can be replaced by several fix cameras, but the aim is to be able to view as exhaustively as possible the inside surface of the pipe from a position of the device that can only be controlled in its longitudinal position. The camera will preferably be equipped with autofocus system.

The camera pointing angle will be in relation to the two directions upper/lower and right/left, and the movements will stay within the inside of the glass dome. This arrangement guaranties the water tightness of the system and may be realized with parts resembling surveillance cameras and anti-vandal glass domes.

According to a fourth characteristic, the device includes a fix, or even swivelling camera at the bottom. The camera is protected by a flat port hole. Depending on its distance to the bottom of the pipe and the water clarity, this camera shows the lower immersed part of the pipe. Observation is possible up to the agitated and turbid zone located between the flowing liquid zone and the pipe. The camera can also visualize the projection of the light beams to the bottom surface as used in sixth characteristic for measuring the distance.

According to a fifth characteristic, the device includes a lighting system that can be built in with the cameras with night vision or can be independent with white or infra red spotlights. Precautions will be taken to avoid light reflection on the inside surfaces of the glass dome.

According to a sixth characteristic, the device includes one or several probes to measure the distance of the pipe walls or of the deposits in relation to the housing. The measurements are in the vertical or horizontal axis.

The systems can be ultra sonic (radar), hydrostatic or optical. An example consists in using two concentrated light beams such as mini red “laser” beams located in the same vertical plane, each on one side of the housing and oriented with relative angle towards the surface to be observed. The distance of the two impacts on the surface as seen by the camera is in proportion to the distance of the housing to the observed surface.

Another example is to equip the float with a hydrostatic probe used to determine the distance to the pipe bottom. It can be made for example of a weighted bulb filled with liquid of a different density than water and connected to the housing by a small pipe. When the bulb drags on the bottom, the difference of density of the liquids and the variation of relative level of the bulb involve a displacement of liquid in the small pipe that is visible on the camera picture.

A piezomeric probe scraping the bottom of the pipe and sending an electrical signal can also be used.

According to a seventh characteristic, the device includes one or several signal transmission/reception systems. Although the transmission of signals via cables would be possible, the wireless systems are considered in priority.

The cameras video signals are either treated by its electronics and transmitted directly in the form of electromagnetic waves toward the receptor located at the upstream (or downstream) visit chamber or are processed by specific transmission systems.

There are plenty of cheap systems widely commercialized and used in the video surveillance market, like wired cameras, wireless cameras with associated reception systems, or wireless cameras with an IP address functioning with WI-FI technology, or in the audiovisual market like wireless audio-video transmitters, or in computer market with WI-FI technology or in high frequency remote control technology.

The antennas are preferably high gain and are arranged in an optimal manner and above water surface for the best results in signal transmission.

The transmission/reception system links the equipment on board of the housing with the corresponding unit put in the upstream (or downstream) visiting chamber, and the latter relays the signals via wire or wireless technology to an observation and possibly recording unit located on the surface of the same chamber.

In the case of a swiveling camera, the relaying unit also transmits the signals from the observation unit to the on board equipment.

According to an eighth characteristic, the device includes an observation and recording unit that treats the signals sent by the relaying unit situated in the nearest chamber.

In addition to its electronics, the observation unit includes a video display and can also include a video recording unit.

TV sets and video recorder can be used, as well as a computer equipped with adequate video jacks or WI-FI connection cards. The computer ensures observation, recording and image processing functions, and can also process directly other types of signals and transcribe the measurements directly into a pipe profile.

### BEST MODE FOR CARRYING OUT THE INVENTION

A standard way of realizing the invention is basically with wireless pan and tilt video surveillance cameras. A router can be used as a relay system at the level of the nearest chamber, and the suitably equipped computer will be used for visualization and recording purposes This configuration is adapted for use by a technician, while a more rustic version using wireless video surveillance equipment linked to a surveillance screen and a video recording system will be used by a less qualified operator.

In both cases, when an obvious defect zone is observed during operation, the operator can control the device and scan more accurately the zone.

### INDUSTRIAL APPLICABILITY

Numerous applications exist for the numerous sewage networks managers.

What I claim is:

1/ Float for inspecting sewer systems, used for collecting information on the condition of a sewer network characterized in that it consists in a set of observation and signal transmission pieces of equipment, said pieces of equipment being battery operated and being mounted on a water tight floating housing (1) held by a check cable linked to a hook located at its rear, said check cable being controlled by an operator located at the surface of the upstream manhole in which a unit receiving the signals has been introduced, said transmission unit being in turn connected to a display unit at the surface near the manhole.

2/ Float for inspecting sewer systems according to claim no 1 characterized in that the system is completed by a visual signal recording system.

3/ Float for inspecting sewer systems according one of the previous claims characterized in that one of said observation equipment is a surface camera (2) housed in a glass dome located at the front part of said floating housing.

4/ Float for inspecting sewer systems according one of the previous claims characterized in that said front camera (2) is of pan and tilt type,

5) Float for inspecting sewer systems according one of the previous claims characterized in that another piece of said observation equipment is a bottom camera (3) housed behind a port view at the front of said floating housing, under the floatation line.

6) Float for inspecting sewer systems according one of the previous claims characterized in that another piece of said observation equipment are concentrated light beams (6), whose trace on the pipe walls give a measurement of the distance from the float,

7/ Float for inspecting sewer systems according one of the previous claims characterized in that said signals transmitted by the device use wireless support widely used for video surveillance applications.

8/ Float for inspecting sewer systems according one of the previous claims characterized in that said display unit is a dedicated standard video screen.

9/ Float for inspecting sewer systems according claims 1 to 8 characterized in that said recording and display units are a computer equipped with wireless transmission cards and recording capacity.

10/ Float for inspecting sewer systems according one of the previous claims characterized in that adequate lamps improve the visibility of the observation equipment.
